(19) United States
(12) Patent Application Publication
(10) Pub. No.: US 2007/0185783 A1
(43) Pub. Date: Aug. 9, 2007

(54) System and Method for locating product data within an electronic catalog

(75) Inventor: Geoffry A. Westphal, Park Ridge, IL (US)

Correspondence Address: GREENBERG TRAURIG, LLP, 77 WEST WACKER DRIVE, SUITE 2500, CHICAGO, IL, 60601-1732, US

(73) Assignee: W.W. Grainger, Inc., Lake Forest, IL (US)

(21) Appl. No.: 11/347,348

(22) Filed: Feb. 3, 2006

(51) Int. Cl. G07F 7/00

(52) U.S. Cl. 705/27

(57) ABSTRACT

A hierarchical menu structure having a plurality of submenus is navigable to a node selectable to request retrieval of a data file containing data related to a product within an electronic catalog. The plurality of submenus includes a plurality of levels of stock number submenus which are to be navigated using the stock keeping unit number for the product, a plurality of levels of product descriptor submenus which are to be navigated using a descriptor associated with the product, and a plurality of levels of brand name submenus which are to be navigated using a brand name of the product. The nodes within navigated to submenus function to indicate at least one alphanumeric character within a sequence of alphanumeric characters which forms stock keeping unit numbers for products, product descriptors associated with products, or brand names of products. The hierarchical menu structure is advantageously used to locate information for products within an electronic catalog stored within the memory of a device that fails to include a physical “qwerty” keyboard, such as an iPod brand portable media player.

### BACKGROUND

This following generally relates to systems and methods for locating product data and, more particularly, to a system and method for locating product data within an electronic catalog using a user interface having limited capabilities, such as the user interface of a portable media player or other device failing to have a physical “qwerty” or the like type of keypad.

Portable media players are well known. For example, U.S. Published Patent Application No. 2004/0224638, which is incorporated herein by reference in its entirety, illustrates and describes portable media players as well as systems and methods for accessing content to be rendered on portable media players. As further illustrated and described in U.S. Published Patent Application No. 2004/0224638, portable media players typically include a user interface having limited capabilities, i.e., the user input device of the portable media player allows a user to perform a limited number of input actions. In this regard, the user input device is limited to a touch pad which is used to simply navigate a hierarchically arranged menu to locate content stored on the portable media player. Navigation using the touch pad only allows a user to navigate up and down within a currently displayed menu, to navigate backward to a previously displayed menu, or to select a currently displayed menu item to further drill down into the hierarchy of menus or to retrieve a currently displayed menu item from memory for rendering by the portable media player.

As further described in, for example, U.S. Pat. No. 6,928,433 which is hereby incorporated by reference in its entirety, certain methods for organizing the hierarchical menus to enable searching for content stored within portable media players are known. Specifically, to allow a user to easily locate and retrieve from the memory of the portable media player desired media content using the simplified user interface, it is known to organize the hierarchical menus such that a user is able to locate media content by drilling down through genres, categories, artists, etc. that are associated with the media content stored on the portable media player. Thus, known hierarchical menus are organized to use various predetermined labels that have been assigned to the media content to thereby allow a user to refine their search for media content of interest via the simplified user interface.

While known systems and methods for locating media content stored on a portable media player generally work for the intended purpose, a need remains for an improved system and method for using the limited user interface of a device, such as a portable media player, to locate product data within an electronic catalog.

### SUMMARY

To address this need, the following describes a system and method for locating information for a product within an electronic catalog. Specifically, a hierarchical menu structure having a plurality of submenus is displayed within the display of a device having a user input device with limited capabilities. The user input device is used to navigate the hierarchical menu structure to a node that is selectable to request retrieval of a data file containing data related to the product. The plurality of submenus includes one or more of a plurality of levels of stock number submenus which are to be navigated using the stock keeping unit number for the product, a plurality of levels of product descriptor submenus which are to be navigated using a descriptor associated with the product, and a plurality of levels of brand name submenus which are to be navigated using a brand name of the product. Furthermore, nodes within the stock number submenus function to indicate an alphanumeric character within a sequence of alphanumeric characters which forms stock keeping unit numbers for products within the electronic catalog, nodes within the product descriptor submenus function to indicate an alphanumeric character within a sequence of alphanumeric characters which forms product descriptors associated with products with the electronic catalog, and nodes within the brand name submenus function to indicate an alphanumeric character within a sequence of alphanumeric characters which forms brand names of products with the electronic catalog. Thus, the organization of the hierarchical menu structure allow the hierarchical menu structure to be easily navigated by selecting nodes within submenus to essentially spell out the stock keeping unit number for the product, a product descriptor for the product, or the brand name for the product.

A better understanding of the objects, advantages, features, properties and relationships of the system and method for using the limited user interface of a device to locate product data within an electronic catalog will be obtained from the following detailed description and accompanying drawing that set forth illustrative embodiments that are indicative of the various ways in which the principles expressed hereinafter may be employed.

### BRIEF DESCRIPTION OF THE DRAWINGS

For a better understanding of the system and method for locating product data within an electronic catalog reference may be had to preferred embodiments shown in the following drawings in which:

FIG. 1 illustrates a device, in the exemplary form of a portable media player, having a limited user interface displaying an exemplary hierarchical menu used to locate product data within an electronic catalog;

FIG. 2 illustrates the exemplary device of FIG. 1 displaying the exemplary hierarchical menu of FIG. 1 with an exemplary first level stock number submenu being displayed as a result of an expansion operation being performed on the exemplary hierarchical menu illustrated in FIG. 1;

FIG. 3 illustrates the exemplary device of FIG. 1 displaying an exemplary first level stock number submenu displayed as a result of a drill down operation being performed on the exemplary hierarchical menu illustrated in FIG. 1;

FIG. 4 illustrates the exemplary device of FIG. 1 displaying an exemplary second level stock number submenu displayed as a result of a drill down operation being performed on the exemplary hierarchical menu illustrated in FIG. 3;

FIG. 5 illustrates the exemplary device of FIG. 1 displaying an exemplary third level stock number submenu displayed as a result of a drill down operation being performed on the exemplary hierarchical menu illustrated in FIG. 4;

FIG. 6 illustrates the exemplary device of FIG. 1 displaying an exemplary fourth level stock number submenu displayed as a result of a drill down operation being performed on the exemplary hierarchical menu illustrated in FIG. 5;

FIG. 7 illustrates the exemplary device of FIG. 1 displaying an exemplary submenu used to access data pertaining to located product(s) within the electronic catalog displayed as a result of a drill down operation being performed on the exemplary hierarchical menu illustrated in FIG. 6;

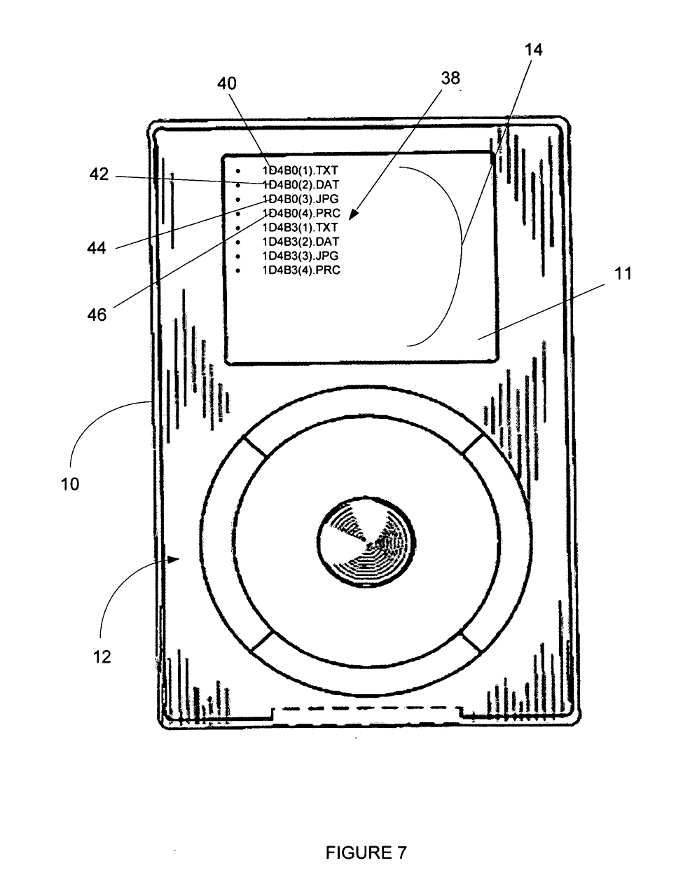

FIG. 8 illustrates the exemplary device of FIG. 1 displaying an exemplary third level model number submenu displayed as a result of multiple drill down operations being performed commencing with a drill down from the exemplary hierarchical menu illustrated in FIG. 1;

FIG. 9 illustrates the exemplary device of FIG. 1 displaying an exemplary fourth level model number submenu displayed as a result of a drill down operation being performed on the exemplary hierarchical menu illustrated in FIG. 8, the exemplary fourth level model submenu including selectable nodes usable to access data pertaining to located product(s) within the electronic catalog displayed as a result of a drill down operation being performed on the exemplary hierarchical menu illustrated in FIG. 8;

FIG. 10 illustrates the exemplary device of FIG. 1 displaying an exemplary first level brand name submenu displayed as a result of a drill down operation being performed on the exemplary hierarchical menu illustrated in FIG. 1;

FIG. 11 illustrates the exemplary device of FIG. 1 displaying an exemplary second level brand name submenu displayed as a result of a drill down operation being performed on the exemplary hierarchical menu illustrated in FIG. 10;

FIG. 12 illustrates the exemplary device of FIG. 1 displaying an exemplary third level brand name submenu displayed as a result of a drill down operation being performed on the exemplary hierarchical menu illustrated in FIG. 11;

FIG. 13 illustrates the exemplary device of FIG. 1 displaying an exemplary submenu including nodes representative of product categories within a selected brand name displayed as a result of a drill down operation being performed on the exemplary hierarchical menu illustrated in FIG. 12;

FIG. 14 illustrates the exemplary device of FIG. 1 displaying an exemplary submenu used to access data pertaining to located product(s) within the electronic catalog displayed as a result of a drill down operation being performed on the exemplary hierarchical menu illustrated in FIG. 13;

FIG. 15 illustrates the exemplary device of FIG. 1 displaying an exemplary first level product descriptor submenu displayed as a result of a drill down operation being performed on the exemplary hierarchical menu illustrated in FIG. 1;

FIG. 16 illustrates the exemplary device of FIG. 1 displaying an exemplary second level stock product descriptor submenu displayed as a result of a drill down operation being performed on the exemplary hierarchical menu illustrated in FIG. 15;

FIG. 17 illustrates the exemplary device of FIG. 1 displaying an exemplary third level product descriptor submenu displayed as a result of a drill down operation being performed on the exemplary hierarchical menu illustrated in FIG. 16;

FIG. 18 illustrates the exemplary device of FIG. 1 displaying an exemplary submenu including nodes representative of sub-product descriptors which are associated with products from within the electronic catalog having a selected product descriptor displayed as a result of a drill down operation being performed on the exemplary hierarchical menu illustrated in FIG. 17;

FIG. 19 illustrates the exemplary device of FIG. 1 displaying an exemplary submenu used to access data pertaining to located product(s) within the electronic catalog displayed as a result of a drill down operation being performed on the exemplary hierarchical menu illustrated in FIG. 18; and

FIG. 20 illustrates a system including the exemplary device of FIG. 1 illustrating various ways that the exemplary device may be adapted to retrieve files from a database server.

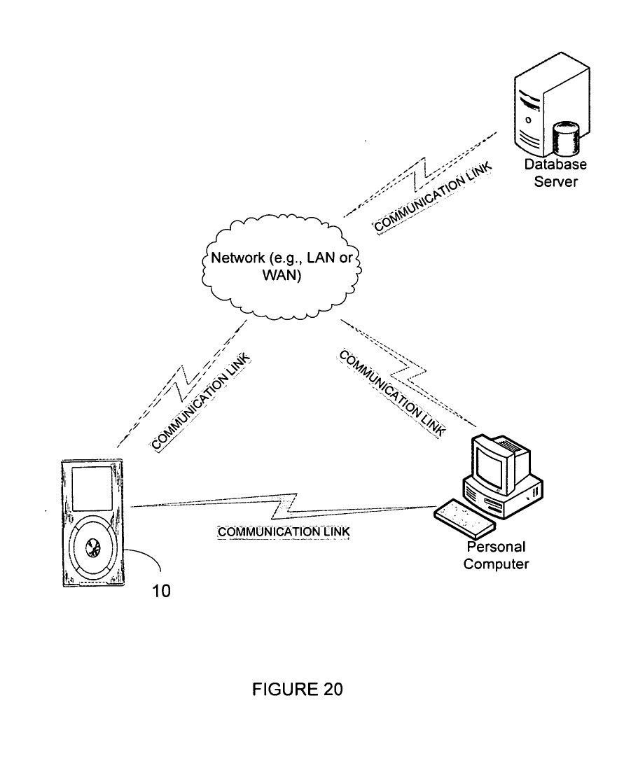

### DETAILED DESCRIPTION

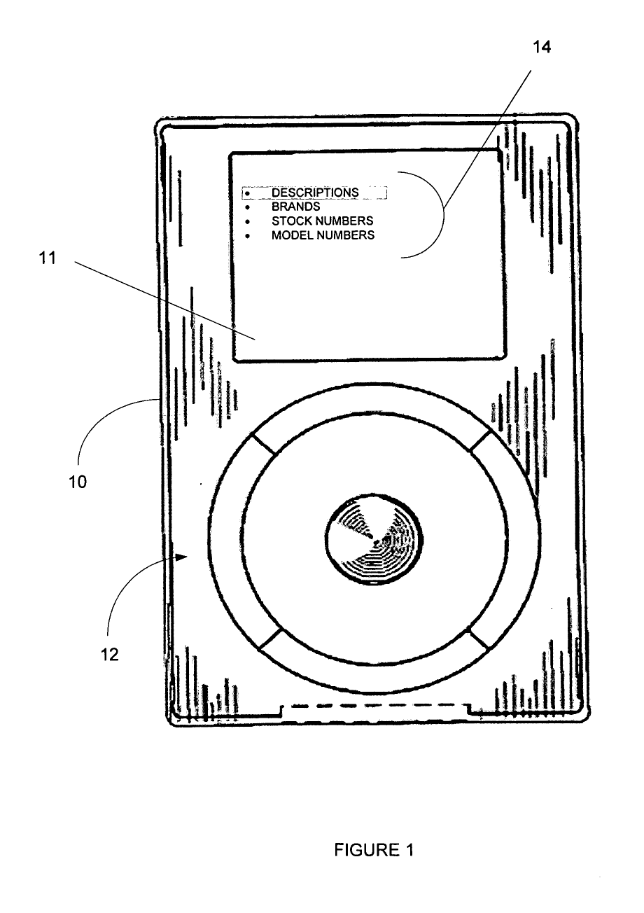

With reference to the figures, wherein like reference numerals refer to like elements, a system and method for using a user interface of a device having limited capabilities to locate product data within an electronic catalog is hereinafter described. By way of illustration only, the device having the limited user interface may be a portable media player 10, such as illustrated in FIG. 1. It is to be appreciated, however, that the device may be any type of device having a user interface which allows for simplistic navigation of a hierarchical menu, e.g., up and down within a displayed menu, backward movement within the hierarchy, drill down within the hierarchy, and selection without the ability to receive input via a physical, “qwerty” keypad. Furthermore, since the elements comprising the device 10, functionality of the elements comprising the device 10, and methods for loading data into the memory of the device 10 are well known in the art, for example being described in the aforementioned U.S. Patent Application No. 2004/0224638, they will not be described herein for the sake of brevity. Similarly, details with respect to the electronic catalog need not be described further herein since those of skill in the art will readily understand that an electronic catalog generally comprises various product records which may include data indicative of one or more of a stock number (“SKU”) for a product, brand name for a product, descriptive or keywords for a product (adjectives and/or nouns), catalog page of a print or electronic image version of the catalog on which the product appears, image for a product, pricing for a product, data sheets for a product, etc. Nevertheless, should the reader desire more information concerning electronic catalogs, the reader is referred to, among others, commonly assigned, U.S. published application 2003/0105680 which U.S. published application for patent is incorporated herein by reference in its entirety.

As noted above, the device 10 illustrated in FIG. 1 allows a user to interact with an input device 12 for the purpose of navigating a hierarchically arranged menu structure 14 presented within the display 11 of the portable media player 10 to find product(s) of interest within an electronic catalog. In this regard, the hierarchically arranged menu structure 14 and the data for products locatable using the hierarchically arranged menu structure 14 may be locally stored within memory of the portable media player 10. Alternatively, only the hierarchically arranged menu structure 14 may be locally stored within the portable media player 10 with the portable media player 10 being further adapted to retrieve product data from a remote source, such as a database server, when a request is ultimately received via the input device 12 to view data for a product located using the hierarchically arranged menu structure 14.

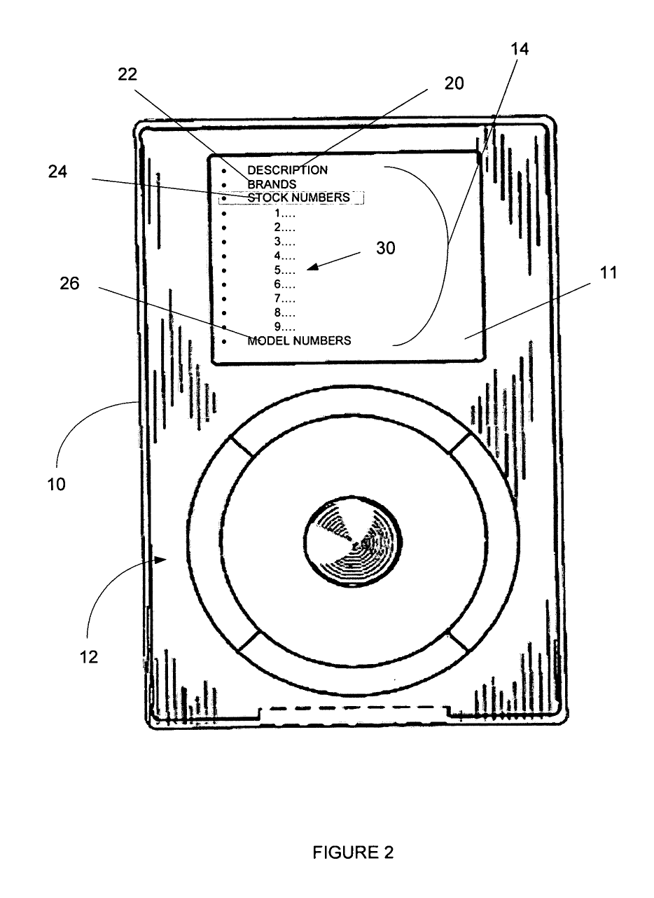

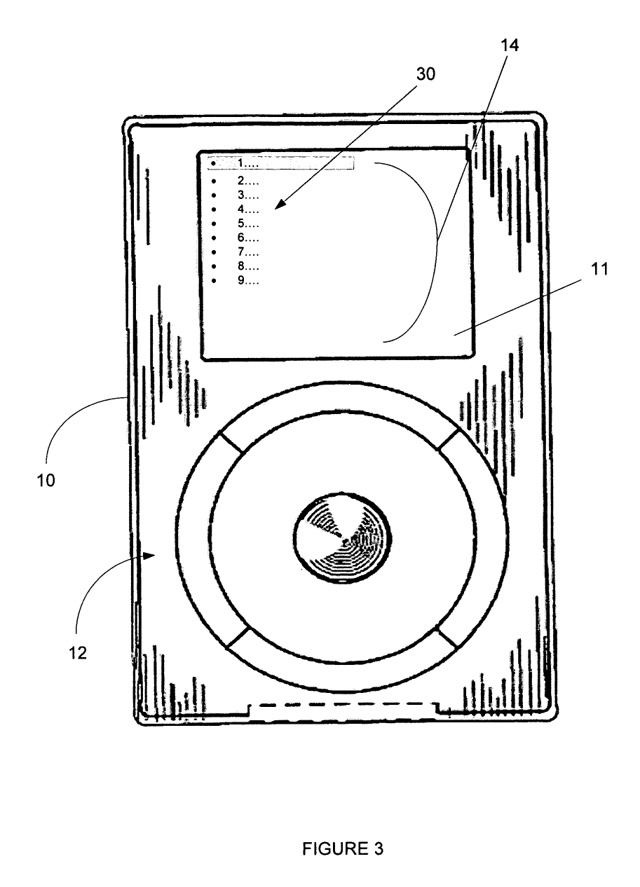

For locating one or more products for which product data, e.g., a picture of the product, specifications of the product, data sheets for the product, pricing for the product, etc., may be retrieved for display within the display 111 of the portable media player 10, the hierarchically arranged menu structure 14 preferably includes multiple, selectable nodes which may be expandable and collapsible as desired (see FIG. 2 for example). Alternatively, upon selection of a node of interest, rather than expand the node a new screen may be presented which shows only the next level of nodes within the hierarchically arranged menu structure 14 (see FIG. 3 for example). As illustrated in FIG. 2, the hierarchically arranged menu structure 14 preferably includes nodes by which a user may navigate the hierarchically arranged menu structure 14 to locate product(s) of interest by product descriptions 20, by brand name 22, by SKU 24, or by other model number 26. It is to be understood that these nodes are presented by way of example only and are not intended to be limiting.

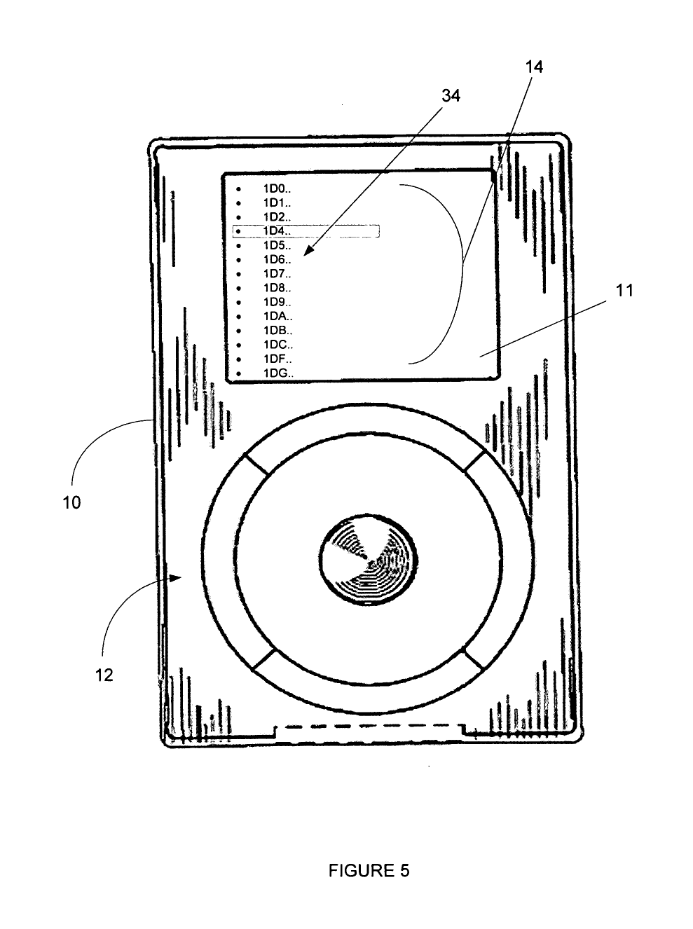

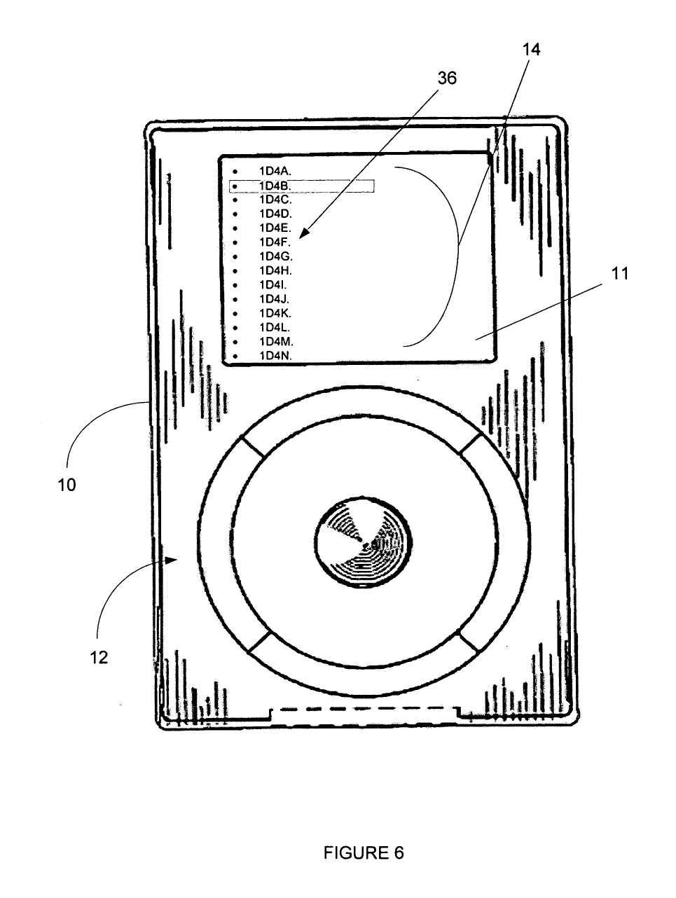

In the event that a user desires to locate product(s) by product SKU, with reference to FIGS. 1-6, the user would first indicate this desire by using the input device 12 to move a position indicator, illustrated in the figures as highlighting that is moveably positionable over the nodes, over the SKU node 24 and then using the input device 12 to select the SKU node 24. In response to the selection of the SKU node 24 of the hierarchically arranged menu structure 14, the system responds by presenting within the display 11 a first level SKU submenu 30, which is illustrated in expanded form in FIG. 2 and in separate drill down form in FIG. 3. In this regard, the first level SKU submenu 30 functions to display selectable nodes each of which corresponds, in the instant case, to one of the possible alphanumeric characters with which the SKUs of products within the electronic catalog may start. While the illustrated example demonstrates that the SKUs of the products with the electronic catalog to be searched start only with a number 1-9, it will be understood that product SKUs may be selected so as to equally start with a character A-Z (where case may or may not matter) or with other typographical symbols.

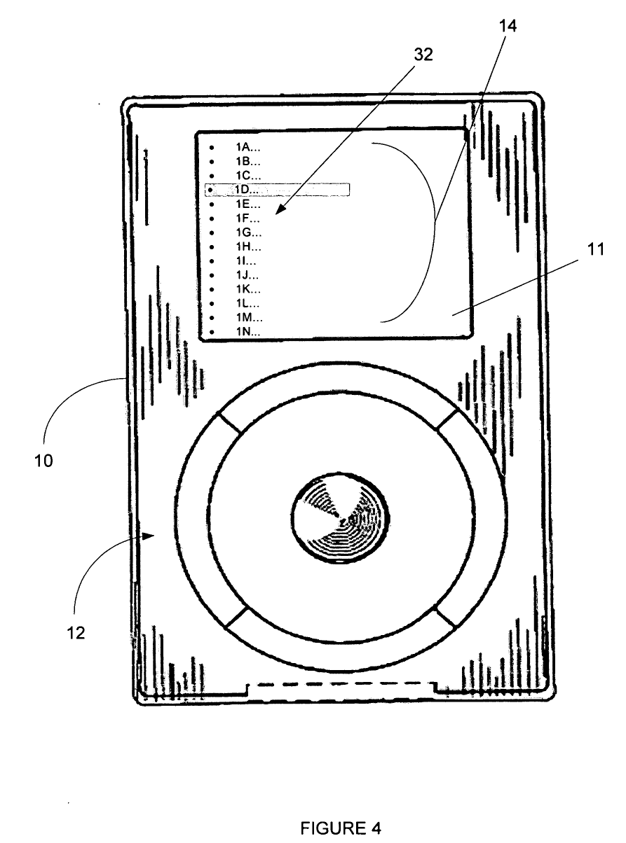

Considering now to FIGS. 3 and 4, a user may further search for product(s) within the electronic catalog by selecting one of the selectable nodes in the first level SKU submenu 30 to which the system responds by presenting a second level SKU submenu 32. It is to be appreciated that, while FIG. 4+ of the application illustrate navigation of the hierarchical menu structure 14 as a series of displayed drill down menus, selection of nodes may equally be used to further expand the hierarchical menu structure 14 in the manner illustrated in FIG. 2. As further seen within FIG. 4, the second level SKU submenu 32 presents selectable nodes which correspond to each of the second alphanumeric characters of the SKUs of products within the electronic catalog while further indicating to the user the first level SKU node from which the second level SKU submenu 32 was accessed. In the illustrated example, since each of the second level SKU submenu 32 nodes start with the number “1” it will be readily apparent to the user that the second level SKU submenu 32 being displayed was accessed from the “1” node of the first level SKU submenu 30 of FIG. 3.

As illustrated in FIGS. 4, 5 and 6, this same process may be continued with the user navigating from the second level SKU submenu 32 to a third level SKU submenu 34 having selectable nodes corresponding to the third possible alphanumeric character of the SKUs within the electronic catalog and from the third level SKU submenu 34 to a fourth level SKU submenu 36 having selectable nodes corresponding to the fourth possible alphanumeric character of the SKUs within the electronic catalog. It is to be understood that these various SKU submenus may include nodes which represent all possible alphanumeric characters or may be limited to display nodes corresponding to only those alphanumeric characters that are used in an SKU at a given level further given the alphanumeric characters of the nodes previously selected by the user to arrive at the currently displayed SKU submenu level. For example, considering a catalog that only has SKUs “1AB456,” “1AB457” and “1AB558” assigned to products, after the level “1AB” has been selected, the forth level SKU submenu may only display a selectable nodes for “4” and “5” (the only valid alphanumerics for product SKUs given the refinement down to the “1AB” level), may display nodes for all alphanumeric characters from which a selection of any node other than “4” may cause the display of a null search indication or may allow the user to further drill down ultimately to a null search conclusion, or may simply display selectable nodes for each of the remaining SKUs (e.g., skip straight to a submenu by which a user may access data relevant to the products represented by all of the SKUs “1AB456,” “1AB457” and “1AB558”) since the number of SKUs presentable to the user has now been reduced to a level that is easily navigated within the display 11 which has a nominal size as is common with portable media players. Additionally, in keeping with the process described above, it will be seen that the nodes within these lower level SKU submenus continue to present to a user an indication from which upper level SKU submenus the currently displayed SKU submenu was reached, e.g., by continuing to include the alphanumeric characters of the nodes that have been selected by the user to reach the currently displayed SKU submenu.

In further keeping with the illustrated example in which the SKUs of the products within the catalog are limited to five alphanumeric characters in length, upon the user selecting a selectable node within the fourth level SKU submenu 36, the user is presented with the fifth level SKU submenu 38 which presents to the user selectable nodes by which the user may request data for a specific product of interest. For example, if the product navigated to, i.e., the product of interest, has a SKU of “1D4B0,” the user may select via the input device 12 node 40 to request retrieval and display of a file (.txt) having a textual description of the product corresponding to SKU “1D4B0,” node 42 to request retrieval and display of a file (.dat) having additional information (e.g., hazmat information) for the product corresponding to SKU “1D4B0,” node 44 to request retrieval and display of a file (.jpg) having an image for the product corresponding to SKU “1D4B0,” or node 46 to request retrieval and display of a file (.prc) having pricing information and/or availability information (e.g., one or more of: number of product available for shipment; location(s) of the product within the supply chain; expected time of shipment/receipt for the product; etc.) for the product corresponding to SKU “1D4B0.” Alternatively, the system may simply provide for the automatic retrieval and display of all or some of these files (which are preferably image files) upon the user selecting a sublevel menu node “1D4B0.” It will be appreciated that other information for the products, which may be stored in other types of files, may also be made available and, as such, these examples are not intended to be limiting. Additionally, it will be understood that the number of levels of SKU submenus used in the example illustrated is similarly not intended to be limiting. Rather, the number of levels of submenus may be tailored as required to achieve the same results. Thus, from the foregoing, illustrative example it will be seen that the subject system and method provides an easy and economical way for a user to locate information for a product (e.g., the product corresponding to SKU “1D4B0”) using a device having limited input capabilities, i.e., one that only allows for navigation of a menu but does not provide for the direct inputting of alphanumeric characters via a physical keyboard.

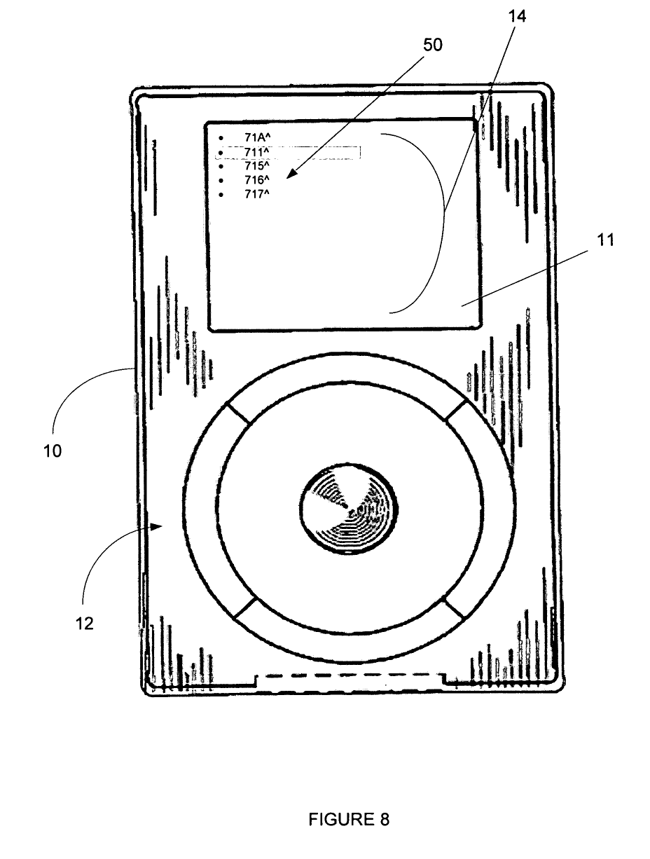

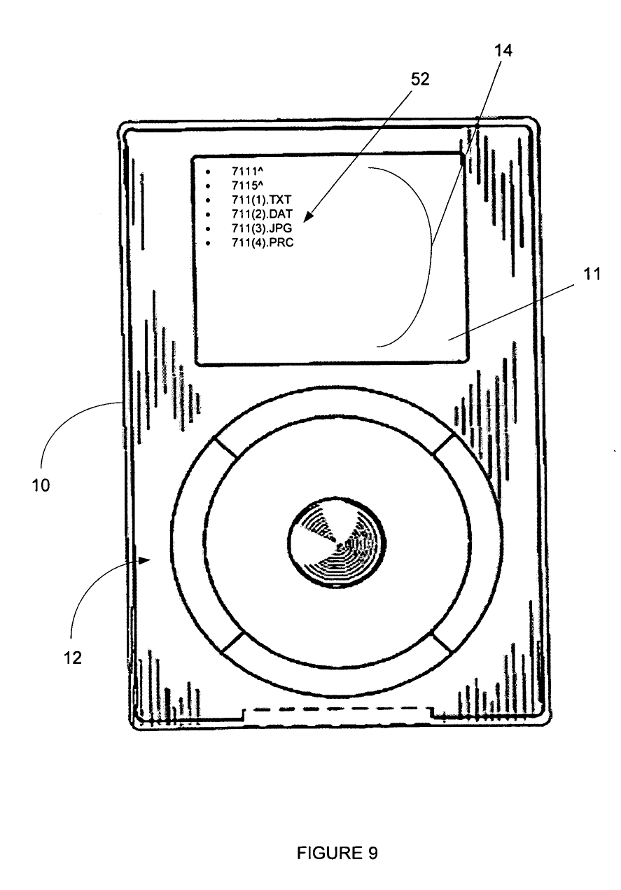

In the case where a user desires to locate products by model numbers, e.g., by commencing the search from node 26 of FIG. 2, it will be understood that a similar process as to that described above may be used with the user navigating levels of submenus such as illustrated in FIG. 8 and FIG. 9 depicting a third level model number submenu 50 and a fourth level model submenu 52, respectively. As further seen in FIG. 9, a submenu level may include both nodes selectable for continued drill down within the hierarchal menu system 14 (for example a node displayed with a “ˆ” a “.” or some other symbol used to indicate that further, lower nodes are accessible under a given node should the node be selected) and nodes that are selectable to access and retrieve one or more data files for a product of interest, e.g., a product having a searched on model number that has been fully indicated by the previous nodes selected by the user (such as the product represented by model no. “711”).

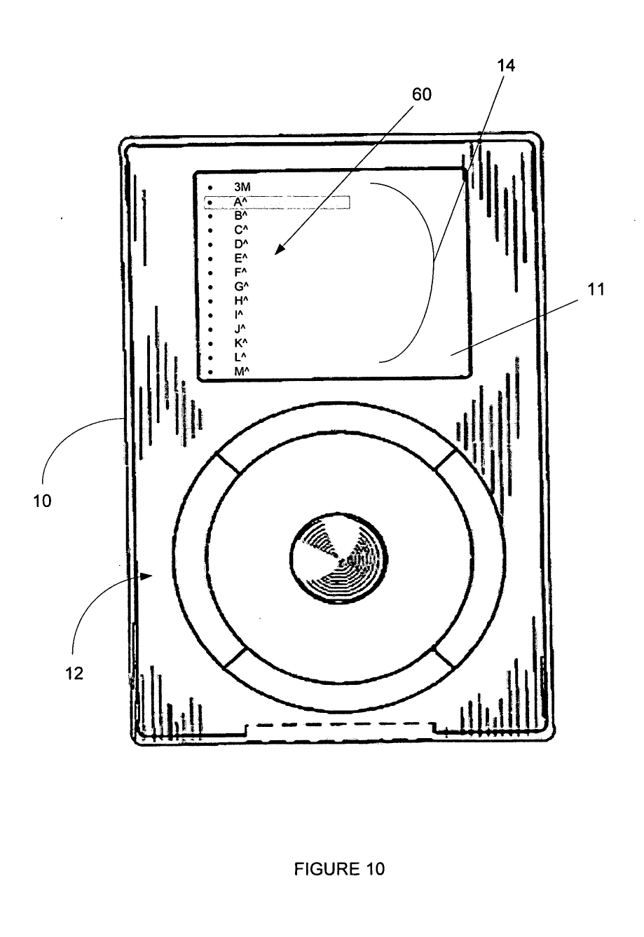

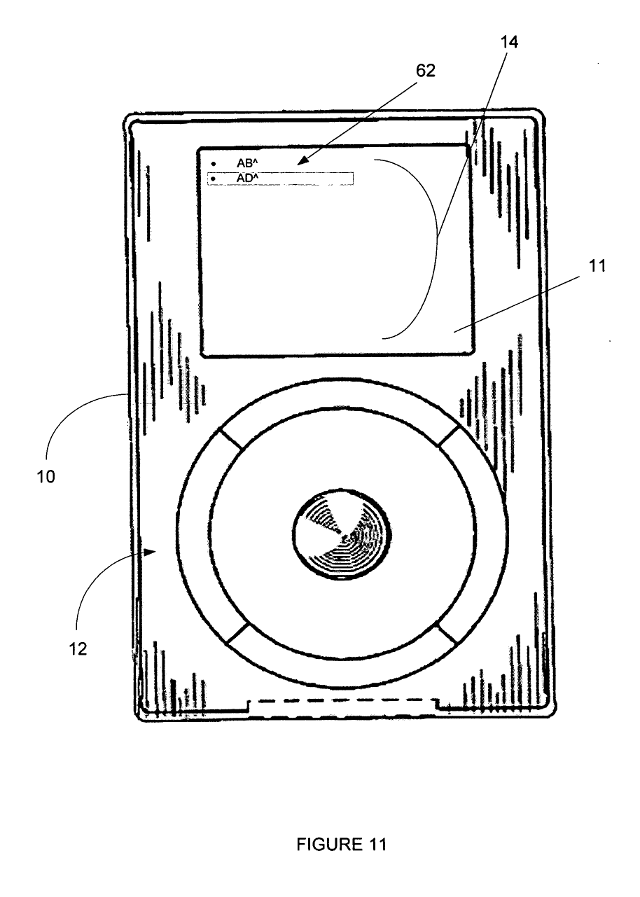

Turning now to FIGS. 10-14, there is illustrated an example by which a user interacts with the hierarchical menu structure 14 to locate product(s) by brand name, e.g., by commencing the search from node 22 of FIG. 2. It will be understood that a search by brand name utilizes a similar process as to that described above. For example, in response to the user selecting node 22 of FIG. 2 a first level brand name submenu 60 is displayed as illustrated in FIG. 10 which includes selectable nodes which corresponds, in this case, to one of the possible alphanumeric characters with which product brand names within the electronic catalog may start. Again, in a manner similar to the submenu illustrated in FIG. 9, the first level brand name submenu 60 presents both nodes which are expandable to further drill down within brand names, e.g., to gain access to a second level brand name submenu 62 as illustrated in FIG. 11, as well as a node, e.g., node “3M,” selection of which will cause the display of a brand name product category submenu 66 having selectable nodes representing various categories of products sold under the brand name selected.

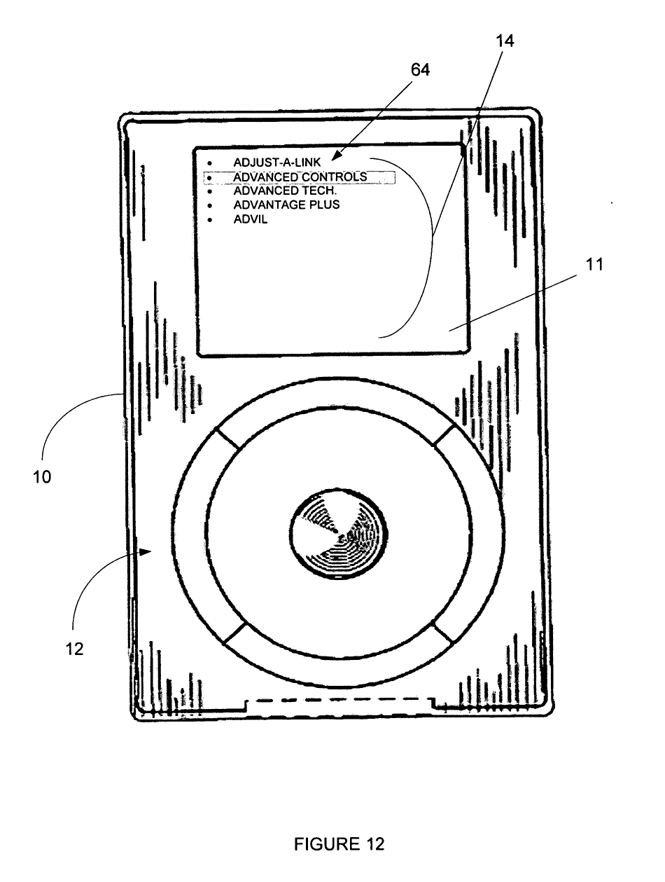

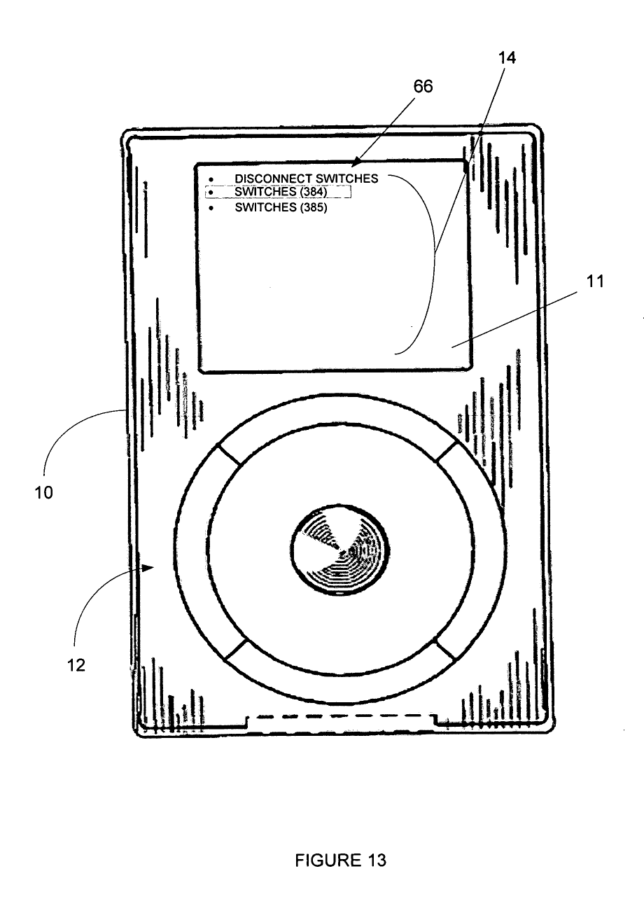

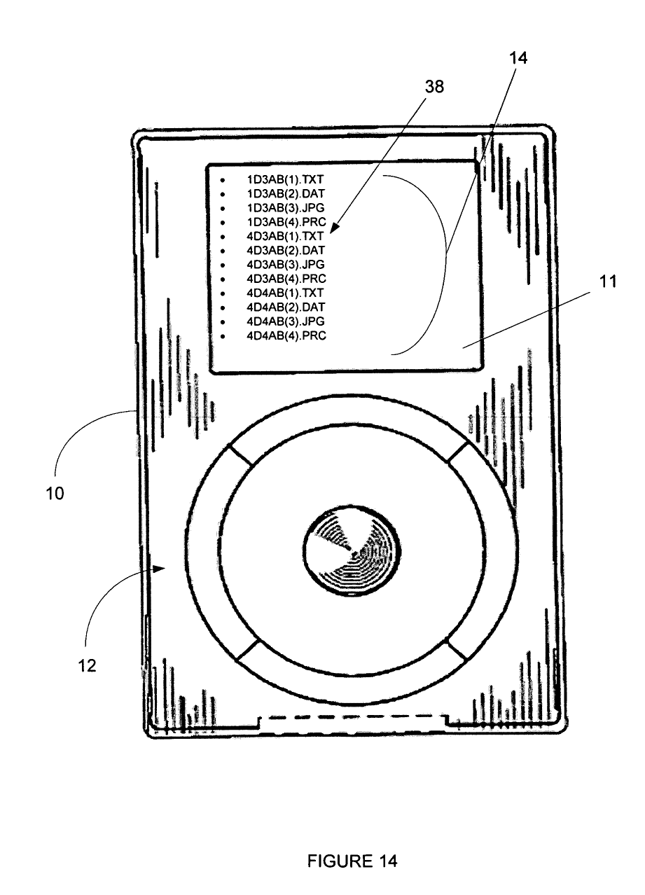

By way of further example, assuming the user has navigated the first level brand name submenu 60 by selecting node “A” and has then navigated the second level brand name submenu 62 by selecting node “AD,” the user would arrive at third level brand name submenu 64 illustrated by way of example in FIG. 12 which, as will be seen, presents in full details all of the brand names for products within the electronic catalog which start with the previously selected “AD” since, in this instance, all of the brand names that start with the letters “AD” are easily presented within the display of the portable media player thus eliminating any need for further drilling down. As may be further seen, since no further drilling down within the brand name is available from the nodes depicted in FIG. 12, selection of a node in the illustrated third level brand name submenu 64 may cause the display of a brand name product category submenu 66 having selectable nodes representing various categories of products sold under the brand name selected, e.g., categories of products within the electronic catalog sold under the brand name “ADVANCED CONTROLS.” As additionally illustrated in FIG. 13, a user may be presented with a catalog page, e.g., the number illustrated in the parenthesis, within a print or electronic image version of a catalog which corresponds to the electronic catalog at which product(s) within the category of the brand name selected may be found. Still further, upon selection by a user of a product category node within the brand name product category submenu 66 the user may be presented with nodes 38 shown in FIG. 14 by which a user may access and retrieve files, as discussed above, relevant to the products within the electronic catalog within the product category of the brand name navigated to by a user using input device 12. While the nodes 38 illustrated in FIG. 14 also indicate the SKUs for the products within the electronic catalog within the product category of the brand name navigated to by the user, it is to be understood that this is shown by way of example only and not intended to be limiting.

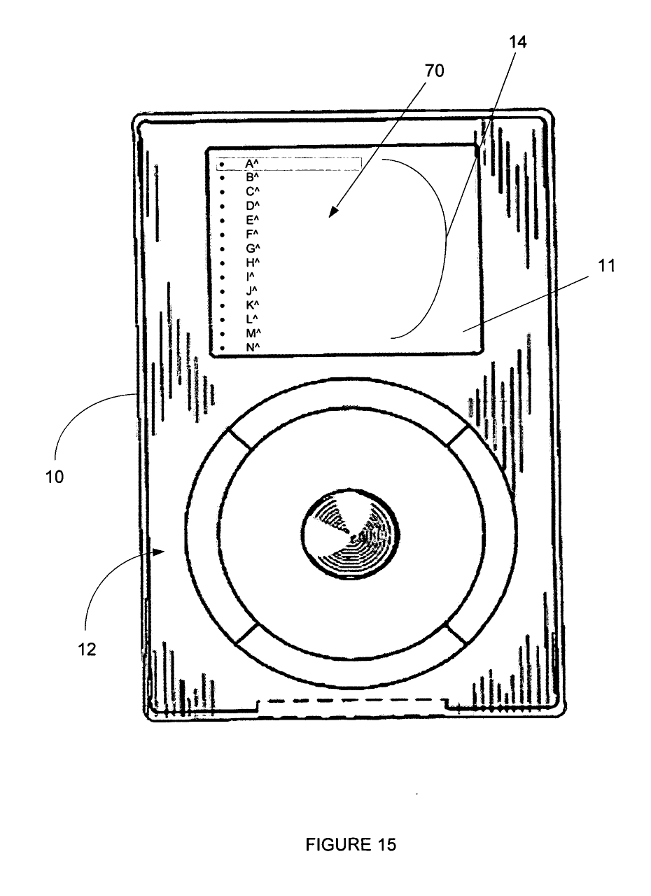

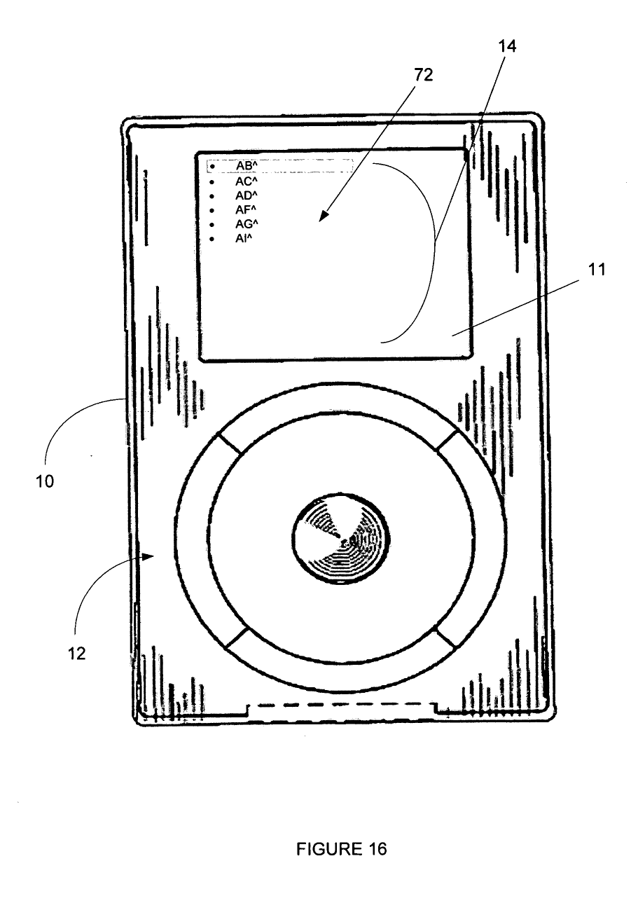

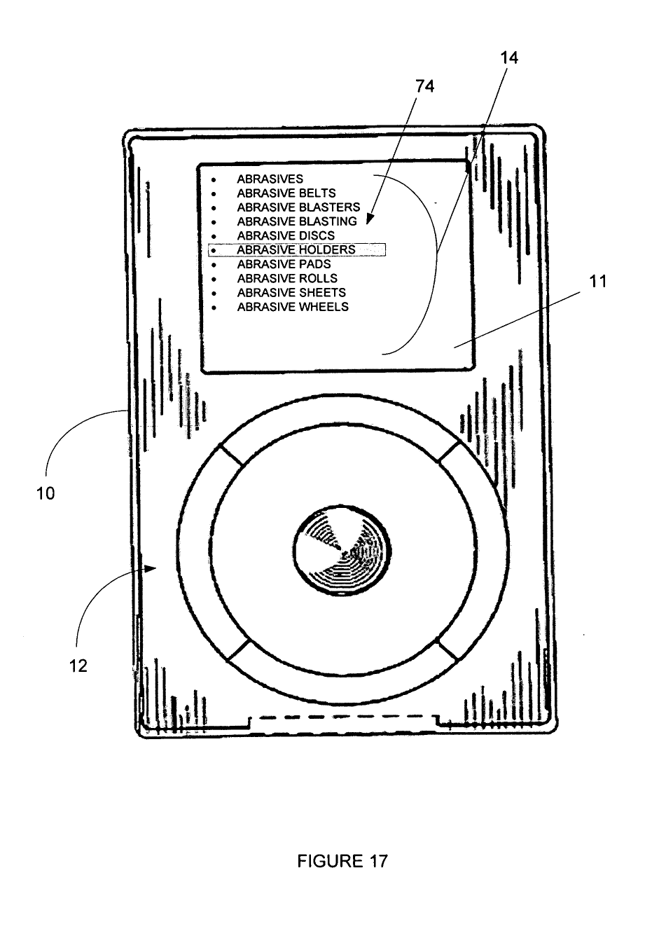

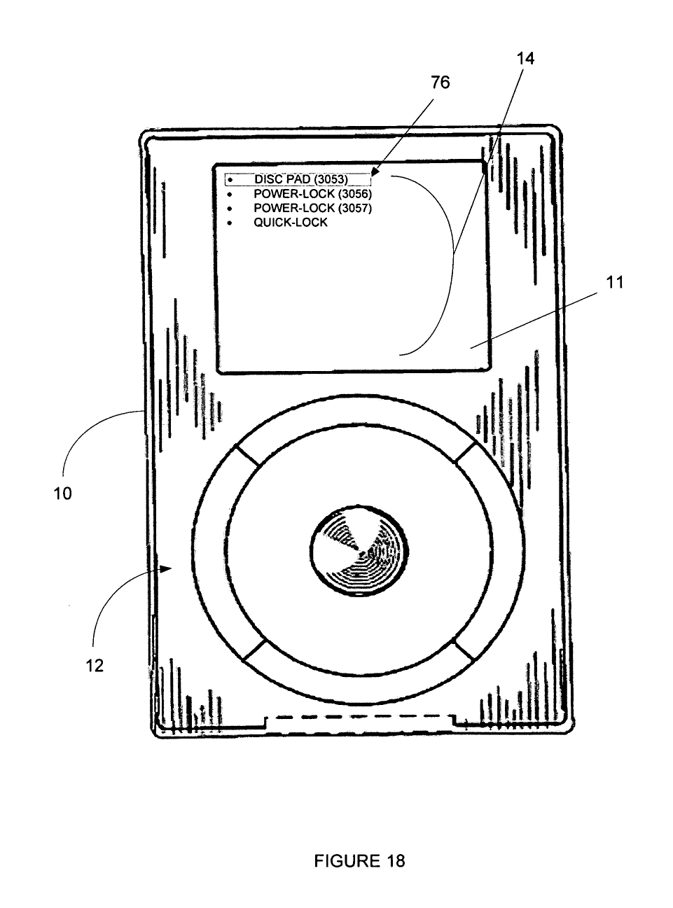

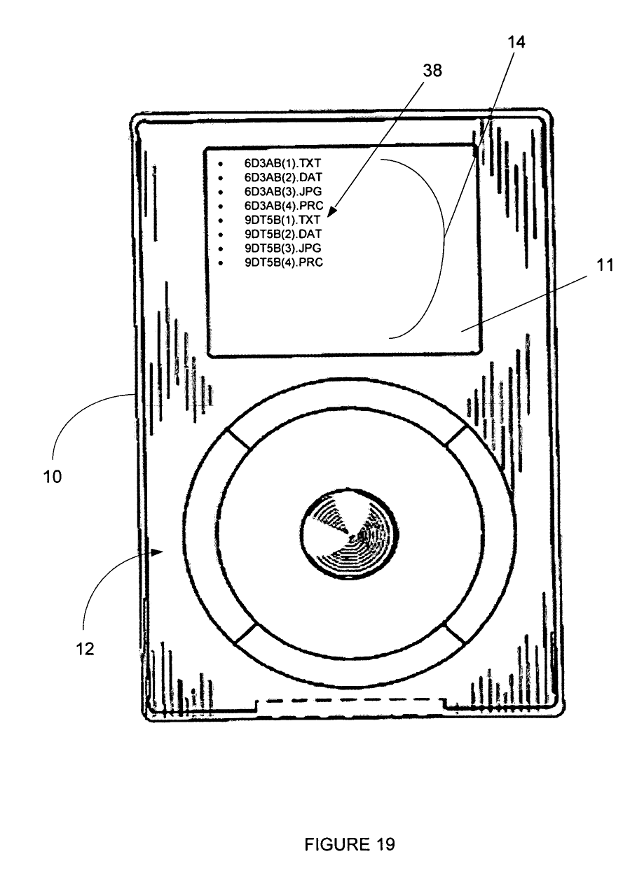

Turning now to FIGS. 15-19, there is illustrated an example by which a user interacts with the hierarchical menu structure 14 to locate product(s) by product descriptor, e.g., by commencing the search from node 20 of FIG. 2. It will be understood that a search by product descriptor utilizes a similar process as to that described above. For example, in response to the user selecting node 20 of FIG. 2 a first level descriptor submenu 70 is displayed as illustrated in FIG. 15 which includes selectable nodes which correspond, in the instant case, to one of the possible alphanumeric characters with which a product descriptor associated with products within the electronic catalog may start. Again, in a manner similar to that described previously with respect to FIGS. 9-14, from the first level descriptor submenu 70 the user may navigate to one or more further levels of descriptor submenus, such as second level descriptor submenu 72 illustrated by way of example in FIG. 16 and third level descriptor submenu 74 illustrated by way of example in FIG. 17. When the user ultimately selects a node within a level of the descriptor submenus which corresponds to a completed product descriptor, i.e., there is no further levels of product descriptor submenus below this node, selection of such a node may cause the display of still further nodes which correspond to more specific product descriptions associated with products under the product descriptor selected via the user navigating the hierarchical menu structure 14, such as the nodes of classification submenu 76 illustrated by way of example in FIG. 18. From the nodes having a complete product descriptor, whether it be a more specific product descriptor such as found in the nodes of submenu 76 or a more general product descriptor such as found in the nodes of submenu 74—especially in the case where there exists no “more specific” descriptions for products under a selected product descriptor node—a user may again navigate to a submenu having nodes 38, such as shown in FIG. 19, by which a user may access and retrieve files, as discussed above, relevant to the products within the electronic catalog having a product descriptor which corresponds to product descriptor(s) navigated to by a user using input device 12.

By way of specific example, assuming the user has navigated the first level product descriptor submenu 70 by selecting node “A” and has then navigated the second level product descriptor submenu 72 by selecting node “AB,” the user would arrive at third product descriptor submenu 74 illustrated by way of example in FIG. 17 which, as will be seen, presents in full details, i.e., completely, the various descriptors used in connection with products within the electronic catalog which start with the previously selected “AB” since, in this instance, all of the product descriptors that start with the letters “AB” are easily presented within the display of the portable media player 10 thus eliminating any need for further drilling down. As may be further seen, a user may refine the product descriptor search by selecting a node within the submenu 74 to thereby gain access to nodes in submenu 76 of FIG. 18 having more specific product descriptors for the general product descriptor selected, in this case the product descriptor “ABRASIVE HOLDERS.” From the nodes of submenu 76 shown in FIG. 18, which in the illustrated example also present a catalog page at which the products having the searched upon descriptor may be found within a print or electronic image version of a catalog which corresponds to the electronic catalog at which product(s) within the category of the brand name selected may be found, a user may select a desired node in response to which the system will present to the user the nodes within submenu 38, shown in FIG. 19, by which a user may access and retrieve files, as discussed above, relevant to the products within the electronic catalog that have the product descriptors navigated to by a user using input device 12. While the nodes of submenu 38 illustrated in FIG. 19 again also indicate the SKUs for the products within the electronic catalog having the product descriptors of interest to the user, it is to be understood that this is shown by way of example only and not intended to be limiting.

While specific embodiments of the invention have been described in detail, it will be appreciated by those skilled in the art that various modifications and alternatives to those details could be developed in light of the overall teachings of the disclosure. For example, it is contemplated that hierarchical menus as described above may be organized to allow for drill down searches to be performed to locate products according to locations at which products may be used or stored, to locate products frequently purchased by a particular customer, etc. Accordingly, the particular arrangement disclosed is meant to be illustrative only and not limiting as to the scope of the invention which is to be given the full breadth of the appended claims and any equivalents thereof.

What is claimed is:

1. A system for locating information relevant to a product within an electronic catalog, comprising:
a device having a display and a means for accepting user input; and
programming for displaying a hierarchical menu structure within the display and for accepting user input received via the means for accepting user input provided to navigate the hierarchical menu structure and to request retrieval of one or more data files containing data related to the product;
wherein the hierarchical menu structure comprises a plurality of submenus navigable to one or more nodes selectable to request retrieval of the one or more data files containing data related to the product wherein the plurality of submenus include a plurality of levels of stock number submenus which are to be navigated using the stock keeping unit number for the product, a plurality of levels of product descriptor submenus which are to be navigated using a descriptor associated with the product, and a plurality of levels of brand name submenus which are to be navigated using a brand name of the product and wherein nodes within the plurality of levels of stock number submenus function to indicate an alphanumeric character within a sequence of alphanumeric characters which forms stock keeping unit numbers for products within the electronic catalog, nodes within the plurality of levels of product descriptor submenus function to indicate an alphanumeric character within a sequence of alphanumeric characters which forms product descriptors associated with products with the electronic catalog, and nodes within the plurality of levels of brand name submenus function to indicate an alphanumeric character within a sequence of alphanumeric characters which forms brand names of products with the electronic catalog.

2. The system as recited in claim 1, wherein the device comprises a portable media player.

3. The system as recited in claim 1, wherein the one or more data files containing data related to the product are locally stored on the device.

4. A method for locating information relevant to a product within an electronic catalog, comprising:
displaying in a display of a device having a means for accepting user input a hierarchical menu structure comprised of a plurality of submenus navigable to one or more nodes selectable to request retrieval of the one or more data files containing data related to the product wherein the plurality of submenus include a plurality of levels of stock number submenus which are to be navigated using the stock keeping unit number for the product, a plurality of levels of product descriptor submenus which are to be navigated using a descriptor associated with the product, and a plurality of levels of brand name submenus which are to be navigated using a brand name of the product and wherein nodes within the plurality of levels of stock number submenus function to indicate an alphanumeric character within a sequence of alphanumeric characters which forms stock keeping unit numbers for products within the electronic catalog, nodes within the plurality of levels of product descriptor submenus function to indicate an alphanumeric character within a sequence of alphanumeric characters which forms product descriptors associated with products with the electronic catalog, and nodes within the plurality of levels of brand name submenus function to indicate an alphanumeric character within a sequence of alphanumeric characters which forms brand names of products with the electronic catalog;
accepting input via the means for accepting user input while changing which submenus of the hierarchical menu structure are displayed within the display as the means for accepting user input is used to navigate the hierarchical menu structure to the one or more nodes selectable to request retrieval of the one or more data files containing data related to the product; and
causing the one or more data files containing data related to the product to be retrieved in response to the means for accepting user input being used to select the one or more nodes.

5. The method as recited in claim 4, comprising displaying the hierarchical menu in the display of a portable media player.

6. The method as recited in claim 4, comprising displaying within at least one of the plurality of submenus at least one node selectable for further navigation within the hierarchical menu structure and at least one node selectable to request retrieval of one or more data files containing data related to a further product within the electronic catalog.

7. The method as recited in claim 4, comprising displaying within at least one of the plurality of submenus an indication of a page within a printed version of the electronic catalog at which the product may be found.

8. The method as recited in claim 4, comprising displaying within at least one of the plurality of submenus a selectable node which includes each alphanumeric character which was selected in a previously displayed submenu whereby at least a portion of the alphanumeric characters with the sequence of alphanumeric characters of the stock keeping unit number, product descriptor, or brand name of the product forms at least a part of the selectable node.

9. A computer readable media having computer readable instructions for use in locating information relevant to a product within an electronic catalog, the computer readable instructions being used to display within a display of a device a hierarchical menu structure comprised of a plurality of submenus navigable to one or more nodes selectable to request retrieval of the one or more data files containing data related to the product wherein the plurality of submenus include a plurality of levels of stock number submenus which are to be navigated using the stock keeping unit number for the product, a plurality of levels of product descriptor submenus which are to be navigated using a descriptor associated with the product, and a plurality of levels of brand name submenus which are to be navigated using a brand name of the product and wherein nodes within the plurality of levels of stock number submenus function to indicate an alphanumeric character within a sequence of alphanumeric characters which forms stock keeping unit numbers for products within the electronic catalog, nodes within the plurality of levels of product descriptor submenus function to indicate an alphanumeric character within a sequence of alphanumeric characters which forms product descriptors associated with products with the electronic catalog, and nodes within the plurality of levels of brand name submenus function to indicate an alphanumeric character within a sequence of alphanumeric characters which forms brand names of products with the electronic catalog.

10. The computer readable media as recited in claim 9, wherein the instructions cause a displaying within at least one of the plurality of submenus at least one node selectable for further navigation within the hierarchical menu structure and at least one node selectable to request retrieval of one or more data files containing data related to a further product within the electronic catalog.

11. The computer readable media as recited in claim 9, wherein the instructions cause a displaying within at least one of the plurality of submenus an indication of a page within a printed version of the electronic catalog at which the product may be found.

12. The computer readable media as recited in claim 9, wherein the instructions cause a displaying within at least one of the plurality of submenus a selectable node which includes each alphanumeric character which was selected in a previously displayed submenu such that a reminder is provided as to which previously displayed submenus were selected.

13. A method for locating information relevant to a product within an electronic catalog, comprising:
displaying in a display of a device having a means for accepting user input a hierarchical menu structure comprised of a plurality of submenus navigable to one or more nodes selectable to request retrieval of the one or more data files containing data related to the product wherein the plurality of submenus include a plurality of levels of stock number submenus which are to be navigated using the stock keeping unit number for the product, a plurality of levels of product descriptor submenus which are to be navigated using a descriptor associated with the product, and a plurality of levels of brand name submenus which are to be navigated using a brand name of the product and wherein nodes within the plurality of levels of stock number submenus function to indicate an alphanumeric character within a sequence of alphanumeric characters which forms stock keeping unit numbers for products within the electronic catalog, nodes within the plurality of levels of product descriptor submenus function to indicate an alphanumeric character within a sequence of alphanumeric characters which forms product descriptors associated with products with the electronic catalog, and nodes within the plurality of levels of brand name submenus function to indicate an alphanumeric character within a sequence of alphanumeric characters which forms brand names of products with the electronic catalog;
accepting input via the means for accepting user input while changing which submenus of the hierarchical menu structure are displayed within the display as the means for accepting user input is used to navigate the hierarchical menu structure to the one or more nodes selectable to request retrieval of the one or more data files containing data related to the product;
causing the one or more data files to be retrieved from a remotely located database server in response to the means for accepting user input being used to select the one or more nodes; and
causing the data related to product in the retrieved one or more data files to be displayed in the display of the device.

14. The method as recited in claim 13, wherein the one or more data files are retrieved from the database server by establishing an Internet connection with the database server.

15. The method as recited in claim 13, wherein the one or more data files are retrieved from the database server by placing the device into communication with a personal computer having internet connectivity to the database server.

16. The method as recited in claim 13, wherein the one or more data files retrieved comprises data related to product availability and the method comprises causing the data related to product availability in the retrieved one or more data files to be displayed in the display of the device.

17. The method as recited in claim 13, wherein the one or more data files retrieved comprises data related to product pricing and the method comprises causing the data related to product pricing in the retrieved one or more data files to be displayed in the display of the device.
